(19) United States
(12) Patent Application Publication
(10) Pub. No.: US 2026/0148244 A1
(43) Pub. Date: May 28, 2026

(54) SYSTEMS AND METHODS FOR ARTIFICIAL INTELLIGENCE ASSISTED COMPLIANCE AUDITS

(71) Applicants: Micah Jay Spieler-Sandberg, Minneapolis, MN (US); Joshua Ryan Bullers, Black Diamond, WA (US)

(72) Inventors: Micah Jay Spieler-Sandberg, Minneapolis, MN (US); Joshua Ryan Bullers, Black Diamond, WA (US)

(21) Appl. No.: 18/960,877

(22) Filed: Nov. 26, 2024

(51) Int. Cl. G06Q 30/018

(52) U.S. Cl. CPC G06Q 30/018

(57) ABSTRACT

A method of auditing compliance regulations includes determining a compliance framework to be audited. The method includes determining individual criteria components for the compliance framework. Further, the method includes determining test concepts for the individual criteria components. The test concepts evaluate controls and evidence for sufficiency in meeting the individual criteria components. The method also includes determining proposed controls and supporting evidence requirements for testing by the test concepts. The method includes applying the proposed control and the supporting evidence to one or more machine learning models that are trained to evaluate the proposed control and evidence against the test concepts. The method also includes determining a compliance result based on an output from the one or more machine learning models. The compliance result indicates a sufficiency of the proposed controls.

### FIELD

The present disclosure relates to artificial intelligence processes.

### BACKGROUND

As the “digital transformation” era continues, almost every company is now a technology company. These technology companies collect, process, and store critical and sensitive information. Companies are often expected to comply with data security and privacy frameworks, regulations, or laws. Many of these compliance programs require regular audits. For a business, managing compliance activities can take a lot of resources, including people, systems, and money. These compliance programs are often confusing and opaque, with limited guidance for individuals trying to navigate their requirements. The audits are typically performed by humans, which introduces bias into the equation. All of these problems culminate in an industry best practice that is rife with error, leading to avoidable issues like data or security breaches and leaks.

As can be seen, there is a need for systems and methods that address the above drawbacks.

### SUMMARY

In one aspect of the present disclosure, a method of auditing compliance regulations includes determining a compliance framework to be audited. The method includes determining individual criteria components for the compliance framework. Further, the method includes using machine learning models to determine test concepts for the individual criteria components. The test concepts evaluate controls and evidence for sufficiency in meeting the individual criteria components. The method also includes using machine learning models to determine proposed controls and supporting evidence for testing by the test concepts. The method includes applying the proposed control and the supporting evidence to one or more machine learning models that are trained to evaluate the proposed control and evidence against the test concepts. The method also includes determining a compliance result based on an output from the one or more machine learning models. The compliance result indicates a sufficiency of the proposed controls.

### BRIEF DESCRIPTION OF THE DRAWINGS

FIG. 1 is a block diagram of a compliance auditing process, according to aspects of the present disclosure; and

FIG. 2 is a block diagram of further steps of the compliance auditing process of FIG. 1, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

As discussed above, current compliance auditing practices are typically derived based on human-oriented processes. The current solutions are either too focused on improving the human auditors'workflow with spreadsheet-like software that makes the human prep work quicker, or their automated testing suites are too rigid, creating a flawed “checklist” style auditing system that limits the opportunities for businesses to innovate with unique system designs. No systems exist that can, at scale, automate the testing of any compliance program without human intervention.

Moreover, systems that rely on rigid expectations of what a business solution looks like and how it operates limit innovation or make them solutions that larger, uniquely operated businesses cannot adopt. These systems also still rely on human auditing for components that don't adhere to the rigid expectations of the monitoring system. Systems that speed up human auditor's work do not solve the issue of inherent bias that human auditing introduces. These auditing programs are not repeatable (in the sense that if you run the same set of tests again with a different human, you're likely to get different results), and these systems cannot be run in automation to give real-time results which means that any issues flagged in control system may not be repaired for many months, which increases the exposure and opportunity for security breaches and data leaks.

Broadly, an embodiment of the present disclosure provides an audit system and methods that can produce descriptions of risk, control, and evidence requirements that would satisfy the requirements of a provided framework or guidelines. The audit system can ingest any compliance framework, meaning that a business can monitor it's compliance against multiple different vectors at once. The audit system can accept any control environment, meaning that businesses are free to innovate on their technology solutions. The audit system requires less human intervention, meaning that it removes bias from the system. The audit system can be run in automation alongside the control system, meaning that it can give real time results which allow businesses to patch compliance flaws much quicker.

By introducing automated processes using AI into the compliance management process, the audit system removes many of the difficult barriers preventing businesses from operating effective compliance programs. By using multi-modal AI technology, the audit system automatically translates complex regulations into multiple repeatable tests that can be run in real-time as controlled systems operate and evidence is collected. The audit system provides compliance managers and business owners confidence in their compliance programs by removing human bias, providing real-time results, and reducing the overall cost or requirement for external, third-party audits to confirm the validity of compliance programs.

Moreover, by using an AI assisted process to do this work, the audit system removes bias from the entire workflow. The audit system can ingest any compliance framework and quickly apply tests against an established compliance program, something that otherwise would take hundreds of people-hours to complete. The audit system can also run in automation alongside the operating control environments to ensure real-time auditing results, something that humans could not do.

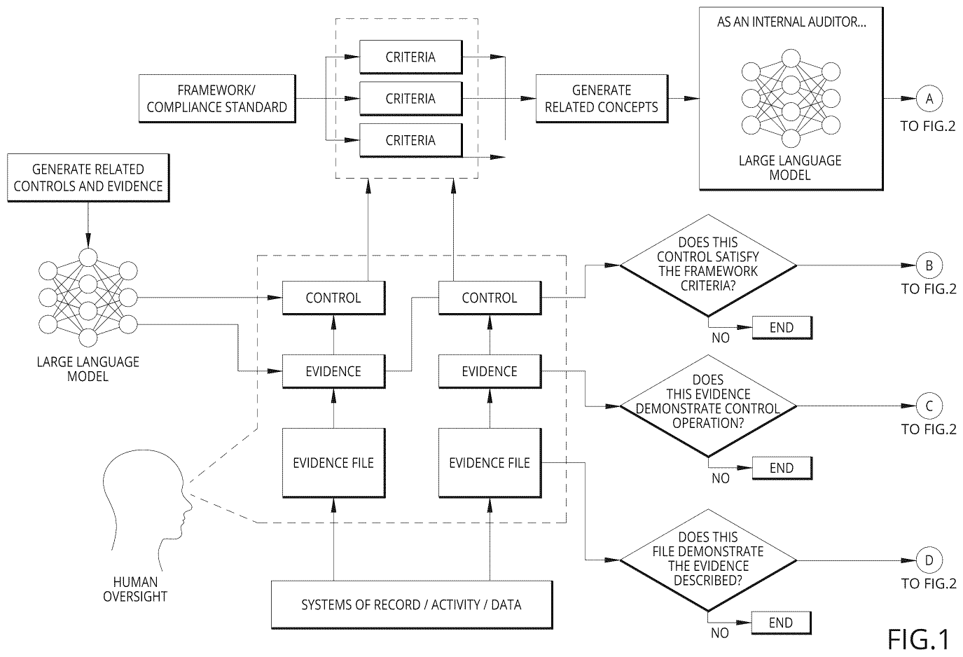

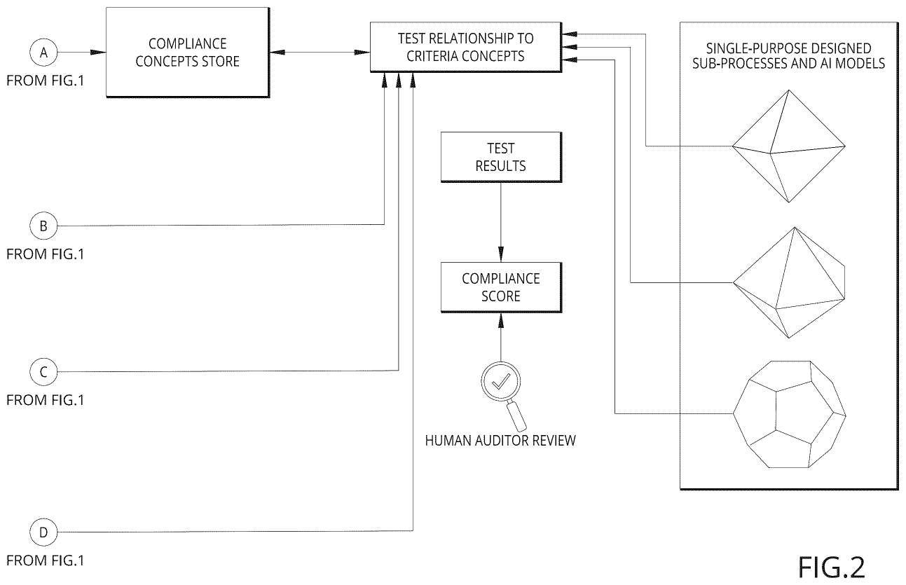

Referring now to FIGS. 1 and 2, FIGS. 1 and 2 illustrate an audit method that can be performed by an audit system, according to aspects of the present disclosure. While FIGS. 1 and 2 illustrate examples of components and stages of the audit method, additional components and stages can be added, and existing components and stages can be removed, reordered, and/or modified.

The audit system takes structured compliance program data, such as compliance framework requirements, compliance control language, or control operation evidence, and processes the data through a multi-model AI system to either generate applicable compliance audit tests, execute said audit tests, or generate suggested control or evidence language. Within this multi-model AI system, multiple general AI models, e.g., Large Language Models (LLMs), and specific single-purpose models, e.g., single-shot or multi-shot classification models, are connected through business logic to determine which model(s) should complete the test that is being performed. Tests can require multiple models to complete, with each model completing different tasks to get a fuller test result.

The audit method, performed by the audit system, begins with determining a compliance framework(s) to be analyzed. For example, a user can select a compliance framework under which compliance should be met. This compliance framework can either already exist in the audit system, or be submitted by the user to be added to the audit system. Examples of compliance frameworks that are managed by a governing body include SOC 2, ISO 27001, and FINRA, however frameworks could also be independently generated by the business for their own unique needs.

The compliance framework(s) are then sent to the audit system's multi-modal AI engine to be broken down into individual criteria components. In some embodiments, the compliance frameworks may already exist with individual criteria, eliminating the need for the audit system's multi-modal AI engine to perform the breakdown. For example, the breakdown may have previously been performed by the audit system's multi-modal AI engine. While the multi-modal AI engine will determine the most effective method for processing the framework, a common process by the AI engine would use semantic language understanding to separate the framework body into smaller individual criteria. The audit system can also determine if there are criteria already present within the compliance framework and decide to ignore the processing step. Once criteria have been determined, the audit system can proceed to generate test concepts. Testing concepts are generated by submitting each criteria into any of the AI models available, determining the most appropriate based on the criteria's content. The AI models will determine appropriate testing concepts, such as “appropriately scoped user access” or “database encryption,” and store those concepts to be used later by the auditing system.

That is, the criteria components are then processed again by the audit system's multi-modal AI engine to generate test concepts. The audit system can determine if there are test concepts already present within the compliance framework. If test concepts already exist, the audit system can either choose to utilize those tests and proceed to identifying controls, choose to replace those tests with generated test concepts before proceeding to generating controls, or choose to add additional test concepts before proceeding to generating controls.

Once the framework is selected and processed, the audit system can run a suite of tests against the relationships to any risks, controls, and evidence that may already be defined and managed by the user in the system and are mapped through relationships to the criteria in the compliance framework.

The test concepts are used by the audit system's multi-modal AI engine to generate an understanding of appropriate controls that could be aligned with the test concepts. In some embodiments, the system controls and/or the evidence may already exist, removing the need for the audit system's multi-modal AI engine to complete that step. In those embodiments, the audit system can determine if the controls already exist, and if they provide adequate coverage for the test concepts. To determine if controls adequately cover the testing concepts, the AI engine can use many different techniques, with one example of such techniques utilizing a process where the engine can compare existing or generated controls to the testing concepts to ensure that the identified testing concepts are present in the control language. The AI engine may also determine if the phrasing or description of the control meets the expected output of standard control phrasing or descriptions. If the controls already exist and have adequate coverage, the audit system can proceed to identify evidence. If the controls already exist and do not provide adequate coverage for the test concepts, the audit system can generate additional controls. If the controls do not exist, the audit system can generate controls.

Evidence requirements, which act as proof that controls are in operation as defined, can also be processed by the audit system's multi-modal AI engine using a similar process and testing concepts described above for controls. For each control identified, the multi-modal AI engine can use the same or similar methods as described above to ensure that there is adequate evidence defined to demonstrate and monitor control operation. By sending each control to the AI engine, the system will determine if the defined evidence requirements that already exist are enough to cover the provided criteria testing concepts, and if not the AI engine will suggest additional evidence to collect to fully demonstrate control operation. Similar to the control definition process above, if evidence requirements do not exist, the AI engine can generate the necessary requirements.

In many embodiments, users will provide documentation of their control operation by attaching artifacts to the appropriate evidence requirement. These artifacts may be uploaded manually using the GUI described below, or collected automatically through integrations built with third party tools. As artifacts are collected and provided to the system, they can be processed by the multi-modal AI engine. The audit system can determine if the evidence requirements have been satisfied (based on the test concepts generated earlier in the process) by submitting the supplied documented artifacts to the AI engine. The AI engine can use a combination of the relational information provided with the artifact, including but not limited to the evidence requirements, control definitions, framework criteria, and testing concepts. The AI engine uses this provided metadata to select the appropriate testing procedure, selecting one or many machine learning models to process the submitted artifact and compare it to the associated testing concepts. If the artifact passes against the testing concepts, the audit system can log a successful result, thus verifying that the artifact satisfies the evidence requirements that demonstrate controls are in operation according to the test concepts defined for the compliance criteria. If the evidence does not pass, the audit system can log an unsuccessful result. The test results include indication as to whether the system is operating in compliance or not. The test results can also provide a detailed analysis of the cause of the compliance or failure.

In some embodiments, the compliance frameworks may already exist with test concepts, providing optionality for the audit system's multi-modal AI engine to either use those tests, generate replacement test concepts, or augment the existing tests with generated test concepts.

A structured compliance program typically has the following data defined: applicable compliance framework(s), business risks, compliance controls, and evidence and artifacts of control operation. Each of these items has many-to-many relationships defined, whereas a control may satisfy multiple compliance criteria, or a single piece of evidence may demonstrate the operation of multiple controls.

Each of these data objects can be tested against their relationships by confirming that the data defined in each object meets the expectations of the objects it has a relationship with. The “testing” is accomplished by sending the relationships to the audit system's multi-modal AI engine to generate concepts that can test the relationships, and then processing them again to verify that each item appropriately satisfies the generated concepts.

The output of the tests will be stored and made available through graphical user interfaces (GUIs) for users who are involved in the compliance management to review as necessary.

Once the framework is selected, the audit system can run a suite of tests against the relationships to risks, controls, and evidence that are defined and managed by the user in the system and are mapped through relationships to the criteria in the compliance framework.

Once a user has reviewed and adjusted their compliance program accordingly, the user can choose to re-run the audit system tests to confirm their changes, or confidently submit their program to a human auditor for verification. The human audit can use the results from the audit system to determine what needs human review and what has already been validated through the audit system's suite of automated tests. Once the human review is complete, the auditor can issue a certificate of compliance.

While the data ontology used for the audit system of automated testing is currently identified with a focus on compliance-related pre-audit activities, the audit system can be used in other verticals where verifying data against a set list of criteria is a required task. For instance, in education, the audit system can be used to verify not only that students are being tested against the educational guidelines defined by the state or federal government, but also that the student's answers to the test questions are adequate. If used in this manner, it would allow teachers to provide lessons (replacing the “control” data object) and test questions (replacing the “evidence” data object), and students would provide free-form answers (replacing the “artifact” data object). The data relationships would then be submitted against the educational guidelines (replacing the “framework” and “criteria” data objects), and the audit system can then work through the various data relationships to verify that the results at all levels are expected.

The audit system described above can be implemented on one or more computer systems. In embodiments, a computer system includes a processing device coupled to a communication device. The processing device is also coupled to a memory device and an input/output (“I/O”) interface. The processing device, the communication device, the memory device, and the I/O interface can be interconnected via a system bus. The system bus can be and/or include a control bus, a data bus, an address bus, and the like.

The processing device can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and the like. As used herein, “processor,” “processing component,” “processing device,” and/or “processing unit” can be used generically to refer to any or all of the aforementioned specific devices, elements, and/or features of the processing device.

The memory device can be and/or include one or more computerized storage media capable of storing electronic data temporarily, semi-permanently, or permanently. The memory device can be or include a computer processing unit register, a cache memory, a magnetic disk, an optical disk, a solid-state drive, and the like. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device.

The communication device can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. programming installed on a processor, such as the processing component, coupled to the antenna.

An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

In embodiments, the components and functionality of the audit system can be hosted and/or instantiated on a “cloud” and/or “cloud service.” As used herein, a “cloud” and/or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the audit system can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “content” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

The computer system can include a user interface for outputting information in a format perceptible by a user and receiving input from the user. The user interface can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The user interface can include an acoustic element such as a speaker, a microphone, and so forth. The user interface can include a button, a switch, a keyboard, a touch-sensitive surface, a touchscreen, a camera, a fingerprint scanner, and so forth. The touchscreen can include a resistive touchscreen, a capacitive touchscreen, and so forth.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A method of auditing compliance requirements and regulations, comprising:
determining a compliance framework to be audited;
determining individual criteria components for the compliance framework;
determining test concepts for the individual criteria components, wherein the test concepts evaluate controls and evidence for sufficiency in meeting the individual criteria components;
determining proposed controls and supporting evidence for testing by the test concepts;
applying the proposed control and the supporting evidence to one or more machine learning models that are trained to evaluate the proposed control and evidence against the test concepts; and
determining a compliance result based on an output from the one or more machine learning models, the compliance result indicating a sufficiency of the proposed controls.

2. The method of claim 1, wherein the individual criteria components are determined by one or more second machine learning models that are trained to parse the compliance framework.

3. The method of claim 1, further comprising:
modifying the proposed controls based on the compliance results;
applying the proposed controls, that were modified, and the supporting evidence to the one or more machine learning models; and
determining a new compliance result based on an output from the one or more machine learning models, the new compliance result indicating a sufficiency of the proposed controls, that were modified.

4. A computer-readable medium storing instructions for causing a processing device to perform a method of auditing compliance regulations, the method comprising:
determining a compliance framework to be audited;
determining individual criteria components for the compliance framework;
determining test concepts for the individual criteria components, wherein the test concepts evaluate controls, evidence requirements, and artifact attachments for sufficiency in meeting the individual criteria components;
determining proposed controls and supporting evidence requirements for testing by the test concepts;
applying the proposed control and the supporting evidence to one or more machine learning models that are trained to evaluate the proposed control and evidence against the test concepts; and
determining a compliance result based on an output from the one or more machine learning models, the compliance result indicating a sufficiency of the proposed controls.

5. The computer-readable medium of claim 4, wherein the individual criteria components are determined by one or more second machine learning models that are trained to parse the compliance framework.

6. The computer-readable medium of claim 4, the method further comprising:
modifying the proposed controls and evidence requirements based on the compliance results;
applying the proposed controls, that were modified, and the supporting evidence to the one or more machine learning models; and
determining a new compliance result based on an output from the one or more machine learning models, the new compliance result indicating a sufficiency of the proposed controls, that were modified.

7. A system of auditing compliance requirements and regulations, the system comprising:
a memory device storing instructions; and
a processing device coupled to the memory device and configured to execute the instructions to perform a method comprising:
determining a compliance framework to be audited;
determining individual criteria components for the compliance framework;
determining test concepts for the individual criteria components, wherein the test concepts evaluate controls and evidence for sufficiency in meeting the individual criteria components;
determining proposed controls and supporting evidence for testing by the test concepts;
applying the proposed control and the supporting evidence to one or more machine learning models that are trained to evaluate the proposed control and evidence against the test concepts; and
determining a compliance result based on an output from the one or more machine learning models, the compliance result indicating a sufficiency of the proposed controls.

8. The system of claim 7, wherein the individual criteria components are determined by one or more second machine learning models that are trained to parse the compliance framework.

9. The system of claim 7, wherein the processing device is configured to execute the instructions to perform the method further comprising:
modifying the proposed controls based on the compliance results;
applying the proposed controls, that were modified, and the supporting evidence to the one or more machine learning models; and
determining a new compliance result based on an output from the one or more machine learning models, the new compliance result indicating a sufficiency of the proposed controls, that were modified.
